(19) United States
(12) Patent Application Publication
(10) Pub. No.: US 2022/0191468 A1
(43) Pub. Date: Jun. 16, 2022

(54) METHOD, DEVICE, SERVER AND SYSTEM FOR CALIBRATING AT LEAST ONE CAMERA OF A DRIVER ASSISTANCE SYSTEM

(71) Applicant: HELLA GUTMANN SOLUTIONS GMBH, Ihringen (DE)

(72) Inventor: Ralph Kolberg, Freiburg i. Br. (DE)

(21) Appl. No.: 17/593,786

(22) PCT Filed: Mar. 21, 2020
(86) PCT No.: PCT/EP2020/057899

§ 371 Date: Sep. 24, 2021

(30) Foreign Application Priority Data
Mar. 26, 2019 (EP) 19165195.9

(51) Int. Cl. H04N 17/00; G06T 7/80; H04N 5/232; G06V 10/74; G09G 3/00; B60R 11/04

(52) U.S. Cl. CPC H04N 17/002; G06T 7/80; H04N 5/23206; H04N 5/23222; G06T 2207/20068; G09G 3/002; B60R 11/04; G06T 2207/30244; G06T 2207/30252; G06V 10/74

(57) ABSTRACT

Disclosed herein is a method for calibrating at least one camera of a driver assistance system, comprising the steps of: imaging a calibration pattern using a display device and transmitting a control command to the camera to capture the calibration pattern imaged by the display device. Further disclosed is a method, a device, a server and a system (100) for calibrating at least one camera of a driver assistance system.

The invention relates to a number of methods, a device, a server and a system for calibrating at least one camera of a driver assistance system.

Nowadays, vehicle manufacturers install different image sensors or cameras for their driver assistance systems. In order for the camera system of the driver assistance system to be adjusted or calibrated according to the manufacturer's specifications, a conventional camera and sensor calibration tool (CSC-tool) requires a variety of manufacturer-specific calibration panels with calibration patterns printed on them. At the moment, these calibration panels have to be replaced each time different vehicle types are calibrated. However, up-to-date calibration panels are not always available, and therefore driver assistance systems of new vehicle types cannot be calibrated.

Known calibration devices are published, for example, in US 2010/0179781 A1, DE 10 2006 056 232 A1, DE 10 2007 021 106 A1 and DE 10 2015 008 551 A1.

It would be desirable to find a practical solution to the problem described.

This problem is solved according to the invention by various methods, a device and a server according to the independent claims. Advantageous refinements are described in the following description and in the dependent claims.

A first method for calibrating at least one image sensor of a driver assistance system is proposed. The method comprises the steps of:
imaging a calibration pattern by means of a display device and
transmitting a control command to the image sensor to capture the calibration pattern imaged by the display device.

Instead of a calibration panel with a calibration pattern printed on it, the calibration pattern is thus imaged by the display device. This means that manufacturer-specific calibration panels with printed-on calibration patterns are no longer necessary. It is also quick and easy to switch between different calibration patterns.

Typically, the display device is not part of the vehicle. In particular, the display device is located outside the vehicle. The image sensor can in particular be a camera or can comprise a camera. Features in the present specification that are disclosed only in conjunction with a camera can thus also be claimed with the image sensor and vice versa.

The display device usually comprises a control and processing unit and an electrically controlled display unit. Prior to the imaging, the display device may receive the calibration pattern, in particular from an external component that is not part of the display device. The method may therefore comprise the step of: receiving, by the display device, the calibration pattern from the external component. The external component may, for example, be located remotely from the display device and/or the vehicle. The external component may comprise, for example, a database or memory in which the calibration pattern is stored. For example, the calibration pattern is transmitted to the display device, preferably via a communication connection. The calibration pattern can also be retrieved from a memory. The display device can receive the calibration pattern as a file or image signal. Thus, the step of obtaining the calibration pattern may comprise:
obtaining an image signal comprising the calibration pattern or
obtaining a file comprising the calibration pattern.

For example, the file may be retrieved from a memory, transmitted to the display device by a communication device, or downloaded from a server. Before obtaining the calibration pattern, the calibration pattern can be requested. If the calibration pattern is available as a file and is transmitted as a file to the display device, the file can be converted into an image signal. The display device comprises, for example, means for converting the calibration pattern present as an image file into an image signal. The calibration pattern can, for example, be in the form of an image file, such as a raster graphic or a vector graphic. In other variants, the display device receives an analogue or digital image signal comprising the calibration pattern. Typically, the display device can process analogue and/or digital image signals.

The calibration pattern is typically sent to the display device from a vehicle diagnostic device and/or a mobile terminal and/or a server. The external component may comprise or be formed by the vehicle diagnostic device, the mobile terminal and/or the server. As explained above, the calibration signal can be sent to the display device as an image signal or file. The vehicle diagnostic device and/or the mobile terminal and/or the server can, for example, be connected to the display device by means of a wired or wireless communication connection.

In this way, current calibration patterns can be transmitted to the display device and imaged by the display device, so that driver assistance systems of newly released vehicle types can also be calibrated without any problems.

The method may comprise the following step of:
confirming that the calibration pattern is displayed by the display device.

When the calibration pattern is successfully imaged by the display device, the display device may send a confirmation to the vehicle diagnostic device and/or the mobile terminal and/or the server. Furthermore, a user input can be used to confirm that the calibration pattern is displayed by the display device. The input can be made, for example, via an input unit provided on the vehicle diagnostic device and/or on the mobile terminal.

Then, the control command can be sent to the image sensor (or the camera). Alternatively, the control command is automatically transmitted to the image sensor or the camera when the display device has received the calibration pattern, i.e. without explicit confirmation, preferably after a certain time has elapsed. The control command is sent to the image sensor or camera, for example, by the display device, the vehicle diagnostic device, the mobile terminal or the server. For example, the control command can be generated by a control unit of the display device, the vehicle diagnostic device, the mobile terminal or the server.

For communication with the image sensor or the camera, the display device and/or the vehicle diagnostic device and/or the mobile terminal and/or the server can be connected to the image sensor or the camera, the driver assistance system and/or a vehicle control device by wire or wirelessly. The driver assistance system and/or the vehicle control device can be designed to forward the control command to the image sensor or the camera. The vehicle diagnostic device is usually connected or connectable to the vehicle control device and/or the driver assistance system by wire via a vehicle diagnostic interface provided in the vehicle.

The wavelength of the imaged light depends on the image sensor or the camera. Typically, the calibration pattern (or a complementary pattern) is imaged using visible light. The display device is typically set up to image the calibration pattern (or a complementary pattern) using visible light. For the purposes of the present disclosure, visible light means, in particular, that the wavelength of the light used for imaging is between 400 nm and 700 nm.

The calibration pattern is typically imaged in a plane or projected in a plane. The plane may be oriented at a predetermined angle, for example substantially perpendicular, to the roadway, i.e. the surface on which the vehicle is located. Furthermore, the plane may be oriented at a predetermined angle, for example substantially perpendicular, to an optical axis of the image sensor or the camera.

For example, the display device may have a screen for displaying the calibration pattern. The screen is typically an electrically controlled display without moving parts for the visual signalling of variable information such as images or characters. The screen can be, for example, an ELD (electroluminescent display), an LCD (liquid crystal display), an LED (light-emitting diode) screen, a plasma screen or the like.

Alternatively, the display device may comprise a display panel and a projector for projecting the calibration pattern onto the display panel. The projector can be, for example, a video projector (also known as an image projector, digital projector, data video projector or beamer). The projector typically comprises a light source and various optical elements, such as mirrors, lenses and/or apertures, for imaging the calibration pattern on the display panel. The projector can, for example, be designed as a retro-reflective projector. The display device may also have at least one laser for imaging and/or projecting the calibration pattern. For example, the projector mentioned above may have the laser. However, the display panel can be dispensed with in some embodiments. Thus, the calibration pattern can be projected by means of said projector into a plane in front of the image sensor or the camera, wherein the plane can be, for example, a vertical wall, a workshop wall or another suitable plane. The calibration pattern is thus projected to a position where it can be detected by the image sensor. The plane can be located at any suitable distance from the image sensor. For example, the plane may be located at a distance where objects are typically located during a subsequent use of the image sensor. Possible projection locations are, for example, walls in front of, behind and/or next to the vehicle.

Various tests carried out by the applicant have shown that better results can be achieved with the display panel and the projector than with a display device designed as a screen.

In addition to the calibration pattern, other images or videos, for example, can also be presented or played back by the display device. For example, calibration instructions for a user would be conceivable.

As already indicated above, the calibration pattern can be stored, for example, as a file in a memory. In this case, the calibration pattern is obtained by requesting it from the memory and/or retrieving it from the memory. The memory may be part of the vehicle diagnostic device and/or the mobile terminal. Alternatively, the memory can be integrated into the display device.

However, the memory can also be connected to the display device by wire (for example USB stick or an external hard drive with cable connected) or wirelessly (for example via Bluetooth or WLAN).

Furthermore, a database can be provided, which comprises a plurality of calibration patterns. The database can, for example, be part of the memory or an external server (see below).

The method may comprise the following steps:
requesting the calibration pattern and
obtaining the calibration pattern for example from the memory or the database.

If the requested calibration pattern is not stored in memory or if no memory is available, the calibration pattern can be requested and/or downloaded from an external location, such as a server with a database and/or a vehicle diagnostic device. If the database comprises a plurality of calibration patterns, it may be advantageous to provide information on vehicle data, as the calibration patterns typically depend on the vehicle type and/or vehicle manufacturer and/or year of manufacture of the vehicle. The vehicle data may thus include, for example, vehicle identification number (VIN), vehicle type, vehicle manufacturer and/or vehicle year of manufacture.

Therefore, the method preferably comprises the following steps of:
inputting and/or transmitting vehicle data, for example to the database, and
obtaining a vehicle-specific calibration pattern from the database.

The vehicle data can be transmitted, for example, by the display device, the vehicle diagnostic device, by the vehicle control device, the driver assistance system or the mobile terminal. The vehicle-specific calibration pattern may be received by the vehicle diagnostic device or the mobile terminal before being transmitted to the display device.

In addition, the following step may be provided: arranging the display device in a calibration position. Before imaging the calibration image, the display device should be oriented and/or positioned in relation to the vehicle, especially in relation to a vehicle leading axle or an unsteered vehicle axle. For example, the display device is oriented and/or positioned in relation to the vehicle, preferably in relation to the vehicle leading axle or the unsteered vehicle axle, before recording the calibration pattern. Hereafter, the calibration pattern presented by the oriented and/or positioned display device may be captured by the image sensor or camera of the driver assistance system. Suitable methods for positioning and orientation as well as positioning means or orientation means are known to a person skilled in the art and are shown for example in the following publications in the name of the applicant: DE 20 2015 008 954 U1, DE 10 2015 112 368 A1, DE 20 2016 103 584 U1, WO 2017/198264 A1, WO 2017/016541 A1, WO 2017/101912 A1 and DE 20 2015 106 939 U1, the scope of which is hereby made part of the present application by reference.

The method may further comprise the following steps of:
determining a distance, position and/or orientation of the display device in relation to the vehicle,
modifying the calibration pattern depending on the distance, position and/or orientation of the display device relative to the vehicle, and
imaging the modified calibration pattern.

In this case, the orientation of the display device can be determined, for example, by means of an orientation sensor. The orientation sensor may include an accelerometer, a gyroscope and a geomagnetic field sensor, each of which can provide accurate acceleration, angular velocity (gyroscopic) and geomagnetic field measurements in any spatial direction.

For the determination of the position of the display device, a measuring tape and/or a position sensor can be used, which comprises, for example, an inductive sensor, a capacitive sensor, a magnetic sensor, an ultrasonic sensor, an opto-electrical sensor, a laser sensor, a distance sensor, a forked light barrier, an angular light barrier and/or a magnetic cylinder sensor.

A measuring tape and/or a distance sensor can be used to determine the distance of the display device relative to the vehicle.

Advantageously, the method additionally comprises the following step of:
modifying a size, position and/or orientation of the calibration pattern.

The display device can shift, rotate, reduce and/or enlarge the calibration pattern to be imaged. This can be done, for example, by adjusting the optics of the display device. Alternatively or additionally, a digital processing of the digitally available calibration pattern can be carried out. For example, the display device may image the calibration pattern shifted, rotated, reduced or enlarged with respect to a default setting.

It is therefore not necessary to orient the display device at an exact right angle to the vehicle axis, as spatial orientations of the display device deviating from a right angle can be taken into account when imaging the calibration pattern. Thus, the effort for positioning and orienting the display device can be significantly reduced. If the display device is placed on an uneven surface, these unevennesses can be compensated by a modified imaging of the calibration pattern.

In addition, an input and output unit may be provided. The input unit can, for example, be part of the display device, the vehicle diagnostic device and/or the mobile terminal. The input and output unit can be used to manually input, for example, the distance, position and/or orientation of the display device in relation to the vehicle. Furthermore, the vehicle data can be input manually via the input and output unit.

The method described above is thus carried out in particular by components (namely display device, external component, vehicle diagnostic device, mobile terminal and/or server) which are not part of the vehicle and are preferably located outside the vehicle.

It should also be noted that the display device, the mobile terminal, the vehicle diagnostic device, the server, the image sensor or camera and the vehicle control device are separate but connectable objects (via a wireless and/or wired communication connection). Depending on the embodiment, the driver assistance system can be separate from the vehicle control device or can comprise the vehicle control device or can form a unit with the vehicle control device.

The method may additionally comprise the following steps:
recording, by the image sensor or camera, the calibration pattern imaged by the display device.

This step typically takes place after the camera has received the control command. The calibration pattern recorded by the image sensor or camera can then be sent to the vehicle control device and/or the driver assistance system for evaluation. The following steps can then be carried out:
comparing the recorded calibration pattern with the calibration pattern and
calibrating the image sensor or the camera based on the comparison.

The comparison and calibration steps can be carried out for example by the driver assistance system and/or the vehicle control device in the vehicle. In other words, the stored target image (calibration pattern) is typically compared with the actual image captured by the image sensor (captured calibration pattern) and the image sensor is further adjusted so that the captured actual image matches the target image in the result. After this, the image sensor is calibrated and functional as intended. The calibration steps carried out in the vehicle are known from the prior art, which is why a detailed description of the calibration is omitted here.

The calibration pattern is typically stored in a memory in the vehicle and is usually compared by the vehicle control device and/or the driver assistance system with the captured image of the calibration pattern in order to perform the calibration of the image sensor or the camera.

Components such as the vehicle diagnostic device, the mobile terminal, the server and the display device, which are not parts of the vehicle, generally do not have access to the calibration pattern stored in the memory in the vehicle. However, they can initiate the calibration of the image sensor or the camera by means of the control command and as such are also part of the calibration process. The actual calibration method is specified by the manufacturer of the used assistance system or by the particular vehicle manufacturer, and as such is not necessarily part of the present invention.

In addition, the present invention provides a second method for calibrating at least one image sensor or a camera of a driver assistance system. The method comprises the following steps:
transmitting a calibration pattern to a display device for imaging the calibration pattern; and
transmitting a control command to the image sensor or the camera to capture the calibration pattern imaged by the display device.

The second method can be performed, for example, by the external component, such as the vehicle diagnostic device, the mobile terminal and/or the server, in particular by an external server which is located, for example, outside the workshop where the display device and the vehicle are located for calibration purposes. The method is particularly suitable for remote calibration of the driver assistance system. The server may have a database comprising a plurality of calibration patterns. The second method can be combined in particular with the first method described above. In particular, the calibration pattern is transmitted by the external component to the display device located outside the vehicle. The control command can optionally be transmitted to the image sensor by the external component or by the display device.

If necessary, a control command can be sent to the display device to image the calibration pattern.

The method may additionally comprise the following steps:
obtaining vehicle data,
reconciling the vehicle data with a database, wherein the database contains vehicle data and associated vehicle-specific calibration patterns, and
transmitting the vehicle-specific calibration pattern to the display device.

Before receiving the vehicle data, a request can be sent to transmit the vehicle data. The vehicle data can be sent to the server after a user has been input. Alternatively or additionally, the vehicle data are sent to the server by a vehicle diagnostic device or a mobile terminal.

Optionally, the following steps may be provided:
obtaining the calibration pattern recorded by the image sensor or the camera,
comparing the calibration pattern recorded by the image sensor or the camera with the calibration pattern,
determining, as a result of the comparison, image sensor settings (or camera settings) that are to be changed, and
transmitting the image sensor settings (or camera settings) to be changed to the image sensor or to the camera.

It should be noted that individual steps and features of the first method and the second method can be combined with one another.

The methods described above are carried out in particular by components (namely display device, external component, diagnostic device, server, database and/or memory) which are not part of the vehicle and are preferably located outside the vehicle.

Furthermore, a device for calibrating at least one image sensor of a driver assistance system is proposed. The device comprises
a display device for imaging a calibration pattern,
a first communication unit designed to transmit to the image sensor a control command to capture the calibration pattern imaged by the display device.

Here, the display device can comprise a screen for displaying the calibration pattern or a display panel and a projector for projecting the calibration pattern onto the display panel (see also above), wherein the display panel can also be dispensed with (see above explanations). The device is typically not part of the vehicle and in particular is located outside the vehicle. In particular, the display device is located outside the vehicle and is not part of the vehicle. In addition, the display device may be configured to receive the calibration pattern from an external component that is not part of the display device.

The device may have at least one control unit. The control unit can be part of the display device, a vehicle diagnostic device, a server, and/or a mobile terminal (see above explanations). The control unit may be configured to generate a control command to record the calibration pattern. The device may further comprise a memory containing a first database comprising a plurality of calibration patterns. The memory can be part of the display device, the vehicle diagnostic device, the server and/or the mobile terminal (see above explanations). The display device may comprise means for obtaining a calibration pattern. Optionally, the display device may have the first communication unit. In this case, it may be provided that the first communication unit is designed to receive the calibration pattern.

The device may additionally comprise an input and output unit for communication with a user. Via the input and output unit, for example commands, data, inputs and/or requests can be input. The input and output unit may be part of the vehicle diagnostic device and/or the mobile terminal and/or the display device.

The first communication unit is preferably designed to communicate with a driver assistance system and/or a vehicle control device. The first communication unit can be designed to transmit data to the vehicle control device and/or the driver assistance system and/or a server. For this purpose, in some embodiments a communication interface on the vehicle may be provided, which is connected or connectable to the vehicle control device and/or the driver assistance system for communication on the one hand and is connected or connectable to the first communication unit on the other hand. The connection can be wireless or wired. The communication interface can thus enable communication between the first communication unit and the vehicle control device or the first communication unit and the driver assistance system. The communication interface can be a vehicle communication interface (VCI) or an on-board diagnostics (OBD) interface. In some embodiments, the VCI may be configured to be connected to the OBD interface.

Furthermore, the first communication unit can be designed to receive data from the vehicle control device and/or the driver assistance system and/or from the server. The first communication unit preferably has a transmitter and receiver unit that enables bidirectional communication. The first communication unit can be designed for wireless and/or wired communication.

The device may comprise a vehicle diagnostic device, which preferably comprises the input and output unit, the first communication unit, the memory and/or the control and processing unit. Additionally or alternatively, the device may have at least one mobile terminal. The mobile terminal may comprise the control device, the first communication unit, the input and output unit and/or the memory. The mobile terminal can be, for example, a tablet, a mobile phone, a smartphone, a laptop and/or a notebook. Such devices usually have an input and output unit, a communication unit, a memory and/or a control and processing unit. In one embodiment, both the vehicle diagnostic device and the mobile terminal are provided. In this case, therefore, at least two input and output units, at least two memories, at least two communication units and/or at least two control and processing units may be provided.

The device may have means for determining a distance and/or position and/or orientation of the display device relative to the vehicle, such as appropriate sensors (see above) and/or a measuring tape or similar. In addition, positioning means and/or orientation means may be provided for positioning or orienting the display device with respect to the vehicle, preferably with respect to the vehicle leading axle or the unsteered vehicle axle. For example, the device may have at least one wheel sensor for determining a position and/or orientation of the display device relative to the vehicle, in particular relative to the vehicle leading axle or to the unsteered vehicle axle. The wheel sensor can be fastened to a wheel of the vehicle. As indicated above, such positioning means and/or orientation means are sufficiently known from the prior art. Reference is made at this point to the documents cited above.

In particular, the device is designed to perform one of the methods described above.

The invention also provides a server. The server comprises a second communication unit, a second control and processing unit connected to the second communication unit, and a second database, wherein the second database comprises a plurality of calibration patterns. The second communication unit is designed for
transmitting the calibration pattern to a display device for imaging the calibration pattern, and
transmitting a control command to the image sensor or the camera to capture the calibration pattern imaged by the display device.

The second communication unit may also transmit a control command to the display device to image the calibration pattern.

In particular, the server is designed to carry out individual or all steps of the first method and/or the second method.

A system is also proposed which includes the above-described device and the above-described server. For example, the second communication unit of the server sends the control command to the first communication unit of the device, which then forwards the control command to the image sensor or camera.

The control devices, control units or control and processing units mentioned in this specification may be or may comprise, for example, processors, microprocessors, controllers or microcontrollers.

It follows from the above that the methods can be carried out in particular by the described device, the server and the system. It should be emphasised here that features mentioned only in relation to the device, the server or the system can also be claimed for said methods, and vice versa. It is understood that the embodiments described above may be combined with each other, provided that the combinations are not mutually exclusive.

In the following, embodiments of the invention are explained in more detail with reference to the accompanying drawings. Here, the figures are schematised and partially simplified. They show:

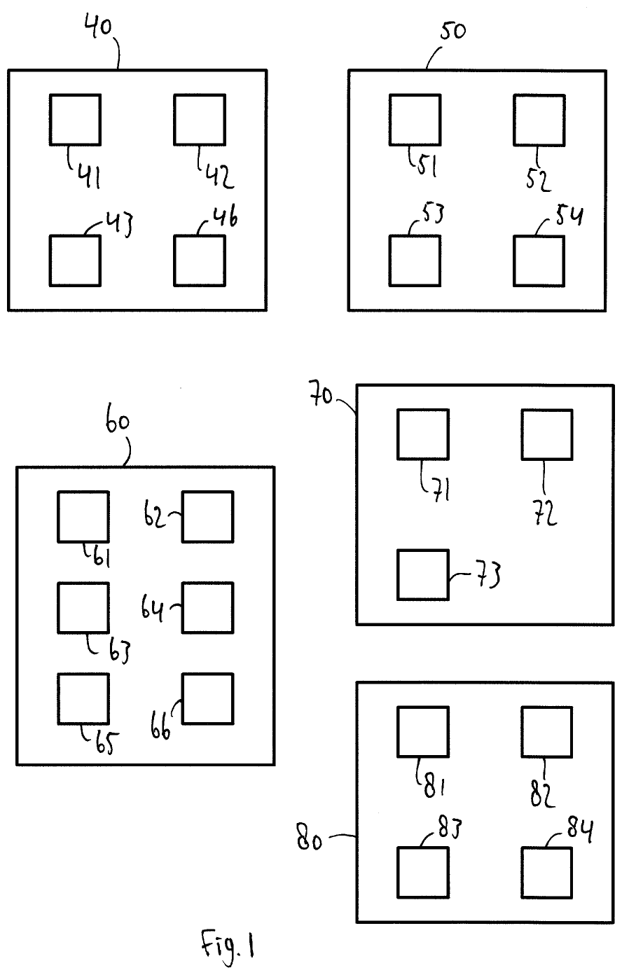

FIG. 1 a schematic representation of a vehicle and various components of a device and system for calibrating a driver assistance system,

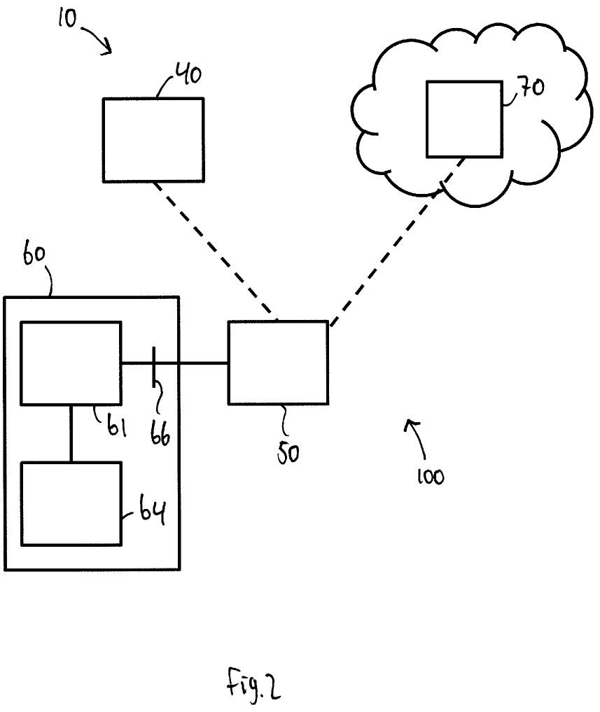

FIG. 2 a schematic representation of a vehicle and various components of a device and system for calibrating a driver assistance system,

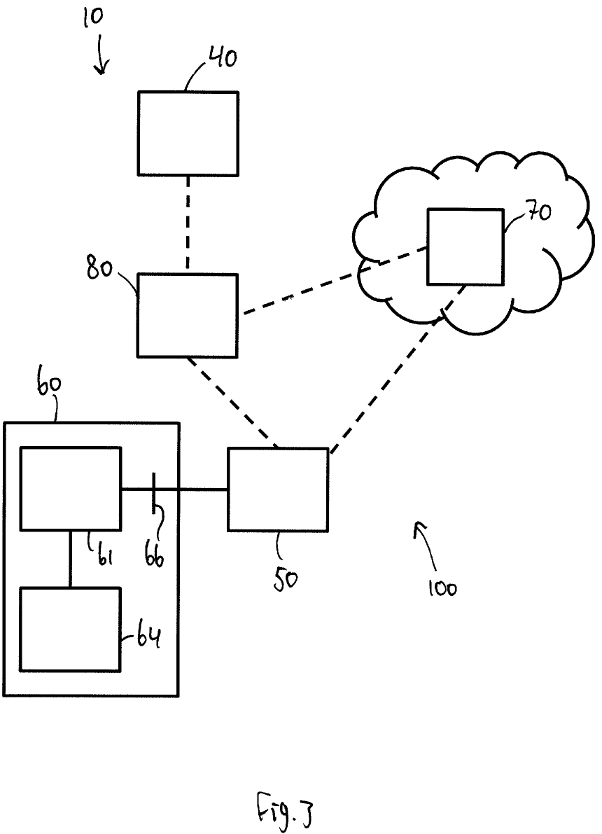

FIG. 3 a schematic representation of a vehicle and various components of a device and system for calibrating a driver assistance system,

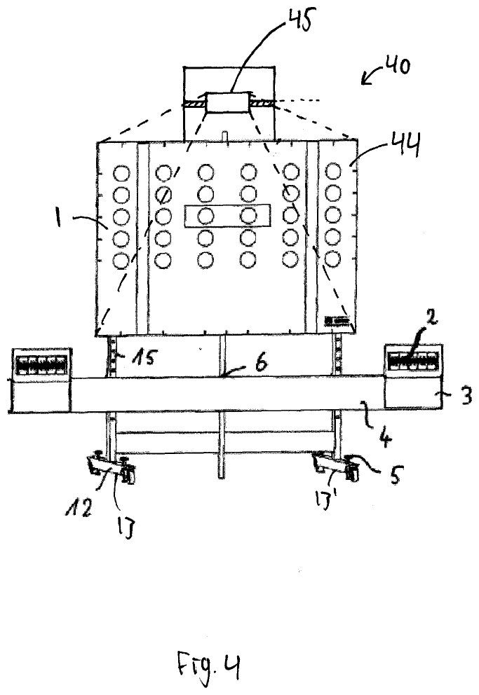

FIG. 4 a display device in a frontal view,

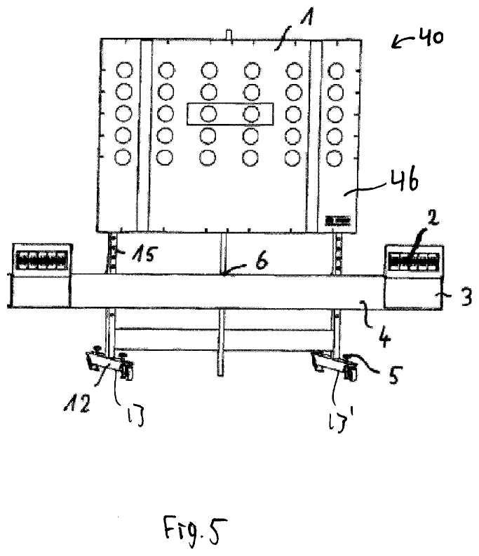

FIG. 5 a further display device in a frontal view,

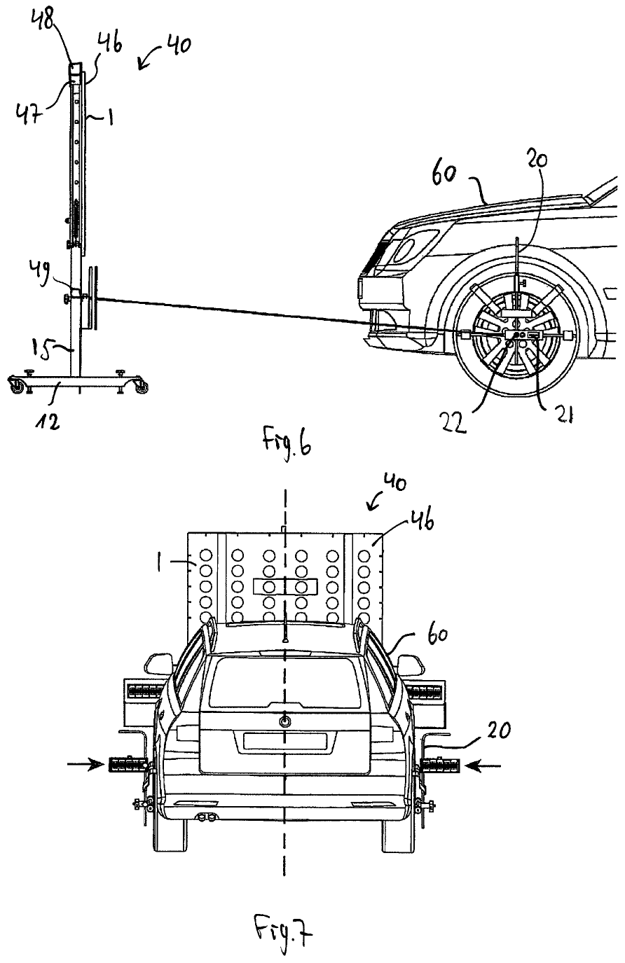

FIG. 6 a side view of the display device of FIG. 5 and of a vehicle positioned in front of the display device, and

FIG. 7 a perspective view of the display device of FIG. 5 and of a vehicle positioned in front of the display device.

In the figures, recurring features are provided with the same reference signs.

First, reference is made to FIGS. 4-7.

FIGS. 4-7 show a display device 40 of a calibration device 10 for calibrating at least one camera 65 or image sensor of a driver assistance system 64. The display device 40 is designed to image a calibration pattern 1. The display device 40 comprises an electrically controlled optical display unit, wherein the optical display unit in FIG. 4 includes an optional display panel 44 and a projector 45 for projecting the calibration pattern 1 onto the display panel 44, and the optical display unit in FIG. 5 is configured as a screen 46. Usually, the calibration pattern 1 is imaged using visible light. The display panel 44 or screen 46 are oriented perpendicular to the roadway and perpendicular to the optical axis of the display device 40. The calibration pattern 1 is thus imaged in a plane that is substantially perpendicular to the roadway and perpendicular to the optical axis of the display device 40. The display device 40 is located outside the vehicle and is not part of the vehicle.

The projector 45 may comprise, for example, a light source and various optical elements, such as mirrors, lenses and/or apertures, for imaging the calibration pattern 1 on the display panel 44. In one embodiment, the projector 45 is designed as a retro-reflective projector. The display device 40 may also comprise at least one laser for imaging or projecting the calibration pattern. For example, the projector 45 comprises such a laser.

According to the illustration in FIGS. 4 and 5, the display device 40 may be attached to a support frame 15. The support frame 15 preferably stands on a chassis 12 provided with four wheels. Furthermore, usually in the area between the calibration panel 1 and the chassis 12, a horizontally arranged adjustment bar 4 is provided, which extends laterally on both sides beyond the optical display unit 44, 45, 46. The adjustment bar 4 is equipped with an adjustment bar scale 2 and an adjustment bar mirror 3 at each of its end areas at both ends. With the aid of the adjustment bar 4, the display device 40 can be positioned and/or oriented with respect to a vehicle 60, in particular with respect to a vehicle leading axle or an unsteered vehicle axle (see also FIG. 6).

Furthermore, the chassis 12 may be equipped with four adjusting screws 5, each of which is arranged in a threaded bore of the longitudinal rails 13, 13 of the chassis 12, which are arranged parallel to one another, in such a way that they are intended to stand adjustably on the supporting substrate of the chassis 12. By means of these adjusting screws 5 the optical display unit 44, 45, 46 can be oriented in such a way that its upper edge is horizontal and its side edges are vertical. The correct orientation of the optical display unit 44, 45, 46 can be checked by means of an adjustment bar spirit level 6 arranged on the adjustment bar 4, since the adjustment bar 4 is also oriented horizontally.

The display panel 44 of FIG. 4 and the screen 46 of FIG. 5 may be attached to the support frame 15 in a height-adjustable manner. For example, the display panel 44 and the screen 46 can each be fixed at an intended height by means of a locking screw.

As a further aid for orienting and positioning the display panel 44 or the screen 46 in relation to the vehicle 60 or the vehicle leading axle or the unsteered vehicle axle, two wheel sensors 20 of identical design may be provided; see FIGS. 6 and 7. The wheel sensors 20 may be attached to the front wheels or rear wheels of the vehicle 60 and each comprise, for example, a laser 21 for determining a position of the display device 40 relative to the vehicle 60.

The details of how the display device 40 with the display panel 44 or screen 46 can be oriented and positioned with respect to the vehicle 60 is disclosed, for example, in the publication DE 10 2015 112 368 A1. In DE 10 2015 112 368 A1 a calibration panel is oriented and positioned which is similar in form and function to the display panel 44 or screen 46 of the present application. In addition, DE 10 2015 112 368 A1 explains further details of the wheel sensors 20 and their functions.

Further, the display device 40 may include an orientation sensor 47 and/or a position sensor 48 and/or a distance sensor 49 (see FIG. 6) and/or a measuring tape for distance measurement.

The orientation sensor 47 can be used to determine a relative or absolute orientation of the display device 40. The orientation sensor 48 may include, for example, an accelerometer, a gyroscope and a geomagnetic field sensor, each of which can provide accurate acceleration, angular velocity (gyroscopic) and geomagnetic field measurements in any spatial direction.

For determining the position of the display device 40 with respect to the vehicle 60 (left, centred or right), the position sensor 48 may be used, which comprises, for example, an inductive sensor, a capacitive sensor, a magnetic sensor, an ultrasonic sensor, an opto-electric sensor, a laser sensor, a distance sensor, a forked light barrier, an angular light barrier and/or a magnetic cylinder sensor. Similar sensors can also be used for the distance sensor 49. The distance sensor 49 is used to determine a distance of the display device 40 to the vehicle 60. Alternatively or additionally, a measuring tape may be used to determine the distance and/or position of the display device 40 relative to the vehicle. The orientation of the display device 40 can be carried out with the aid of at least one spirit level.

Thus, with the aid of the means described above, the means disclosed in DE 10 2015 112 368 A1 and/or further means, it can be ensured that the display device 40 can be positioned and oriented in front of a vehicle 60 in such a way that a calibration of a camera 65 of a driver assistance system 64 or of an image sensor of a driver assistance system 64 can be performed. In particular, the display device 40 can be positioned at a defined distance and centrally in front of the vehicle 60 and at right angles to the longitudinal axis of the vehicle.

FIGS. 1-3 show the display device 40, a vehicle diagnostic device 50, a vehicle 60 and a server 70. FIGS. 1 and 3 also additionally show a mobile terminal 80.

Some of the components 40, 50, 70, 80 shown in FIG. 1 are parts of a calibration device 10 or a system 100 for calibrating a driver assistance system 64. In particular, the device 10, the server 70 and the system 100 may be used to implement the methods described further below.

First of all, we will start from FIGS. 1 and 2. FIGS. 1 and 2 show a vehicle 60 in which a vehicle control device 61, which is also known as an ECU, a communication unit 62, a memory 63, a driver assistance system 64, a camera 65 and a diagnostic interface 66 may be provided.

The diagnostic interface 66 is sometimes also called an OBD interface (on-board diagnostics interface). As a rule, the vehicle diagnostic interface 66 is located in a footwell of the vehicle 60 and is designed as a socket. The vehicle diagnostic interface 66 is connected to at least one vehicle control device 61 located in the vehicle 60 via corresponding signal lines. The vehicle control device 61 is in turn connected to at least one camera 65 of a driver assistance system 64, which is designed to capture images of an immediate environment of the vehicle 60. The at least one camera 65 may be arranged, for example, in or on a windscreen of the vehicle 60.

The operating principle of the driver assistance system 64, the camera 65 and the vehicle control device 61 and the communication between the driver assistance system 64 and the vehicle control device 61 are known from the prior art and are only briefly outlined below. The camera 65 can be designed to take pictures at regular intervals. The camera 65 may also be configured to take pictures after receiving a control command. The camera 65 usually receives the control command from the vehicle control device 61. The vehicle control device 61 may be configured to receive the control command from another unit and to forward it to the camera 65. The camera 65 can send the images at regular intervals to the vehicle control device 61, where they are subsequently evaluated. The digital images can also be forwarded to other units by the vehicle control device 61. The captured images can be temporarily stored or permanently stored in the memory 63 of the vehicle 60 designed for this purpose. It should also be noted that the operating principle of the driver assistance system 64, the camera 65 and the vehicle control device 61 is specified by the manufacturer of the driver assistance system and thus does not necessarily form part of the present invention.

Furthermore, FIG. 2 shows a calibration device 10 for calibrating the camera 65 of the driver assistance system 64. The device 10 comprises the display device 40 and the vehicle diagnostic device 50.

The display device 40 has already been described in conjunction with FIGS. 4-7. FIG. 1 schematically shows again the display device 40 of FIGS. 4-7, which may comprise a control and processing unit 41, a communication unit 42, a memory 43 and the screen 46. As explained in conjunction with FIG. 4, instead of the screen 46, the display panel 44 and the projector 45 can also be provided. Typically, the control unit 41 of the display device 40 can process analogue and/or digital image signals.

Further, FIG. 1 shows a vehicle diagnostic device 50, which may comprise a control and processing unit 51, a communication unit 52, a memory 53, and an input and output unit 54 for communication with a user. Vehicle diagnostic devices 50 are known from the prior art. Usually, the vehicle diagnostic device 50 can be connected to the vehicle diagnostic interface 66 of the vehicle 60 by means of signal lines. The vehicle diagnostic device 50 typically has a plug compatible with the vehicle diagnostic interface 66. When connecting the plug to the vehicle diagnostic interface 66, both are connected to one another electrically and mechanically.

As already sufficiently known from the prior art, the vehicle control device 50 can be designed to read out error codes (diagnostic trouble code, DTC) stored in the vehicle. After this, the error codes can be analysed by the vehicle diagnostic device 50 to diagnose whether and which vehicle components need to be repaired or replaced in order to correct the problem. Thus, by means of an evaluation of the error codes (vehicle diagnostics), a conclusion can be made as to which vehicle components are defective and require repair.

Typically, the communication unit 52 of the vehicle diagnostic device comprises a first transmitter and receiver unit (not shown), which is designed for wired communication with the vehicle control device 61. Further, the communication unit 52 may comprise, for example, a second transmitter and receiver unit (not shown) for wirelessly communicating with the display device 40 (or the communication unit 42 of the display device 40), which typically operates according to a previously known radio standard or radio protocol. The first transmitter and receiver unit and the second transmitter and receiver unit of the vehicle diagnostic device 50 may be connected to each other, either directly or via the control unit 51, such as a processor or a controller. The control unit 51 of the vehicle diagnostic device 50 may control a communication between the first transmitter and receiver unit and the second transmitter and receiver unit of the vehicle diagnostic device 50.

In particular, the communication unit 52 (or the second transmitter and receiver unit of the communication unit 52) may comprise a Bluetooth unit, a WLAN (for example according to IEEE 802.11) or another unit designed to communicate with the communication unit 42 of the display device 40 via a near-field connection. Other wireless connections such as EnOcean, Z-Wave, ZigBee, WiMAX, UMTS/HSDPA, LTE (long term evolution), NanoNetm, UWB (Ultra Wideband), NB-IoT (Narrowband Internet of Things), Sigfox or LoRa are also possible for the communication of the first communication unit and are known to a person skilled in the art. Alternatively, the vehicle diagnostic device 50 may communicate with the display device 40 by wire. The transmitter and receiver units 52, 42 are thus designed to communicate with each other wirelessly or by wire.

The communication unit 52 may be adapted to transmit a control command to the camera 65 to capture the calibration pattern 1 imaged by the display device 40. In addition, the communication unit 52 may be configured to transmit or forward the calibration pattern 1 to the display device 40.

In one embodiment, the memory 43 and/or the memory 53 comprise a database comprising a plurality of calibration patterns 1.

FIGS. 1-3 further illustrate a server 70. The server 70 may have, for example, a control and processing unit 71, a communication unit 72 and a database 73. Preferably, a plurality of calibration patterns are stored in the database 73. In addition, associated vehicle data, such as vehicle identification number (VIN), vehicle type, vehicle manufacturer and/or year of manufacture of the vehicle 60, are stored in the database 73.

The communication unit 72 may be designed to transmit the calibration pattern 1 to the display device 40. In addition, the communication unit 72 may be designed to transmit a control command to the camera 65 to capture the calibration pattern 1 imaged by the display device 40.

The communication unit 52 of the vehicle diagnostic device 50 may be further designed to communicate with the communication unit 72 of the server 70. The communication of the vehicle diagnostic device 50 with the server 70 may be by wire and/or wireless. A person skilled in the art is familiar with the fact that communication with the communication unit 72 of the server 70 can take place via intermediate network components, such as base stations and/or further servers.

The control unit 51 of the vehicle diagnostic device 50 may be designed to handle or to process received data from the server 70 and/or the vehicle control device 61. If necessary, data can be temporarily stored or buffered in a memory 53 designed for this purpose before being forwarded to another component. The memory 53 may store a program for controlling the electronic components of the vehicle diagnostic device 50.

The server 70 and the device 10 together form a system 100 which is suitable and/or designed in particular for calibrating the camera 65.

Instead of the vehicle diagnostic device 50, a vehicle communication interface (VCI, not shown) may also be connected to the vehicle diagnostic interface 66. The vehicle communication interface may be, for example, an adapter having a plug for mechanical and electrical connection to the vehicle diagnostic interface 66. Further, the adapter may comprise a communication unit for communicating with the communication unit 42 of the display device 40 and/or the communication unit 72 of the server. The adapter may in particular be designed to enable communication between the display device 40 and the vehicle control device 61 or between the server 70 and the vehicle control device 61.

Furthermore, FIG. 3 shows a calibration device 10 for calibrating the camera 65 of the driver assistance system 64. The device 10 comprises the display device 40, a vehicle diagnostic device 50 and a mobile terminal 80. Compared to the embodiment in FIG. 2, the mobile terminal 80 is also shown additionally in FIG. 3. The mobile terminal 80 can be, for example, a tablet, a mobile phone, a smartphone, a laptop and/or a notebook. The mobile terminal 80 usually has a control and processing unit 81, a communication unit 82, a memory 83 and an input and output unit 84.

Typically, the communication unit 82 comprises a transmitter and receiver unit (not shown) for wirelessly communicating with the communication units 42, 52 and 72 or the aforementioned adapter, which transmitter and receiver unit typically operates according to a previously known radio standard or radio protocol. For possible wireless connections, refer to the connections mentioned in relation to communication unit 52 (see above). Additionally or alternatively, the communication of the communication unit 82 with the communication units 42, 52, 72 or the adapter may also take place by wire. The mobile terminal 80 is configured to receive, forward and/or process data from the vehicle diagnostic device 50 and/or the server 70 and/or the adapter.

The vehicle diagnostic device 50 is configured to receive, forward and/or process data from the vehicle control device 61, the camera 65, the driver assistance system 64, the server 70, the display device 40 and/or the mobile terminal 80. The display device 40 is configured to receive and/or process data from the vehicle diagnostic device 50 and/or the mobile terminal 80.

In the following, for the sake of simplicity, reference will mainly be made to the display device 40, the vehicle diagnostic device 50, the camera 65, the server 70 and the mobile terminal 80. However, it is clear that communication between these units is via the corresponding communication units 42, 52, 62, 72, 82 and that the control/processing of any data or signals is carried out by the corresponding control and processing units 41, 51, 61, 71, 81.

In particular, the device 10 and/or the system 100 of FIG. 2 or FIG. 3 may be used to perform the following method for calibrating the camera 65 of the driver assistance system 64.

First, the display device 40 is oriented and positioned in front of the vehicle 60 in such a way that a calibration of the camera 65 can be performed. Thereafter, the display device 40 positioned and oriented in front of the vehicle 60 displays the calibration pattern 1. A control command is then sent to the camera 65. The control command causes the camera 65 to record the calibration pattern 1 imaged by the display device 40. The control command may in particular be sent to the camera 65 by the communication unit 52 of the vehicle diagnostic device 50. In this case, the vehicle control device 61 receives the control command from the vehicle diagnostic unit 50 and forwards the control command to the camera 65. Alternatively, the control command is sent from the server 70 to the camera 65. In this case, the control command is sent from the server 70 to the vehicle diagnostic device 50 and from there to the vehicle control device 61, which in turn forwards it to the camera 65. The control command may also be sent to the camera by the mobile terminal 80 via the vehicle diagnostic device 50 and the vehicle control device 61.

After receiving the control command, the camera 65 records the calibration pattern 1 imaged by the display device 40. The images taken by the camera can be evaluated on the vehicle side by the control unit 61 in order to calibrate the camera 65. This allows the images from the camera 65 to be compared with a calibration pattern 1 stored in the memory 63 in the vehicle. The camera 65 is then calibrated based on the comparison.

Alternatively, the images captured by the camera 65 of the calibration pattern 1 imaged by the display device 40 are sent to the vehicle diagnostic device 50 and/or to the server 70, where the images from the camera 65 are then compared with the calibration pattern 1. For example, camera settings to be changed can be determined by the comparison. The camera settings to be changed are then sent to the vehicle control device 61 or the camera 65.

Prior to imaging, the display device 40 may request and receive the calibration pattern 1. For example, the vehicle diagnostic device 50 transmits the calibration pattern 1 stored in the memory 53 to the display device 40.

Alternatively, the display device 40 may retrieve the calibration pattern 1 from the memory 43. The calibration pattern 1 may also be obtained from the database 73 of the server 70 in a further embodiment. In this case, the vehicle diagnostic device 50 forwards the calibration pattern 1 to the display device 40. According to a variant, the mobile terminal 80 can also transmit the calibration pattern 1 to the display device 40.

In order for the display device 40 to obtain the correct calibration pattern 1, vehicle data, such as VIN, vehicle type, vehicle manufacturer and/or year of manufacture of the vehicle, may be transmitted to the components 50, 70, 80 beforehand. Thereafter, the calibration pattern 1 corresponding to the vehicle data is sent to the display device 40 by the corresponding components 50, 70, 80.

The display device 40 may receive the calibration pattern 1 as a file or image signal. Thus, the step of obtaining the calibration pattern 1 may comprise:
obtaining an image signal comprising the calibration pattern 1 or
obtaining a file comprising the calibration pattern 1.

Upon receipt of the calibration pattern 1, a confirmation of receipt may be sent to the component that transmitted the calibration pattern 1 to the display device 40. After receiving the confirmation, the corresponding component can transmit the control command to the camera 65. As a result, the camera 65 takes a picture of the calibration pattern 1 imaged by the display device 40.

The orientation, position and distance of the display device 40 can be determined with the aid of the orientation sensor 47, the position sensor 48 or the distance sensor 49 or the measuring tape. Since the calibration pattern 1 is electronic or digital, the sensor data from the sensors 47, 48, 49 can be used to process the calibration pattern 1 before it is displayed. In addition or alternatively, the distance, position and/or orientation of the display device 40 relative to the vehicle 60 may be manually input, for example, via one of the input and output units 54, 84. Position, distance and orientation could thus also be determined and input manually, for example using the measuring tape. The input unit may, for example, be part of the display device 40, the vehicle diagnostic device 50 and/or the mobile terminal 80. In this way, the calibration pattern 1 can be imaged depending on the distance, position (left/right) and orientation of the display device 40 relative to the vehicle 60. For example, a size, position and/or orientation of the calibration pattern 1 imaged by the display device 40 may be adjusted depending on the position and/or orientation of the display device 40 with respect to the vehicle 60. The display device 40 may modify the calibration pattern 1 to be imaged, such as shifting, rotating, reducing and/or enlarging it, and image the modified calibration pattern 1. Alternatively or additionally, the projector 45 may be rotated or shifted (to the left/right or to the rear/front) relative to the display wall 44 in order to modify the calibration pattern 1 imaged on the display wall 44. Instead of the projector 45, at least one optical component (such as lenses, mirrors, apertures, etc.) used in the projector 45 may also be shifted to modify the calibration pattern 1 projected onto the display panel 44.

Features mentioned only in relation to individual components, the device 10, the server 70 or the system 100 can also be claimed for the methods described and vice versa, provided they do not contradict each other.

### LIST OF REFERENCE SIGNS

1 Calibration pattern
2 Adjustment bar scale
3 Mirror
4 Adjustment bar
5 Adjusting screws
6 Spirit level
10 Calibration device
12 Chassis
13 Longitudinal rail
13′ Longitudinal rail
15 Support frame
20 Wheel sensor
21 Laser
40 Display device
41 Control and processing unit
42 Communication unit
43 Memory
44 Display panel
45 Projector
46 Screen
47 Orientation sensor
48 Position sensor
50 Vehicle diagnostic device
51 Control and processing unit
52 Communication unit
53 Memory
54 Input and output unit
60 Vehicle
61 Vehicle control device
62 Communication unit
63 Memory
64 Driver assistance system
65 Camera
66 Diagnostic interface
70 Server
71 Control and processing unit
72 Communication unit
73 Database
80 Mobile terminal
81 Control and processing unit
82 Communication unit
83 Memory
84 Input and output unit
100 System

1. A method for calibrating at least one image sensor of a driver assistance system, the method comprising:
imaging a calibration pattern by mans of using a display device located outside a vehicle; and
transmitting a control command to the image sensor to capture the calibration pattern imaged by the display device.

2. The method according to claim 1, further comprising:
requesting the calibration pattern, and
obtaining the calibration pattern from at least one of a database or a memory.

3. The method according to claim 2, further comprising:
at least one of inputting or transmitting vehicle data; and
obtaining a vehicle-specific calibration pattern from the database.

4. The method according to claim 1, further comprising:
determining at least one of a distance, a position, or an orientation of the display device in relation to the vehicle,
modifying the calibration pattern depending on at least one of the distance, the position, or the orientation of the display device relative to the vehicle; and
imaging the modified calibration pattern.

5. The method according to claim 4, further comprising:
modifying at least one of a size, a position, or an orientation of the calibration pattern.

6. The method according to claim 1, wherein the display device includes at least one of:
a display panel and a projector for projecting the calibration pattern onto the display panel; or
a screen for imaging the calibration pattern.

7. The method according to claim 1, further comprising:
obtaining at least one of an image signal comprising the calibration pattern or a file comprising the calibration pattern.

8. The method according to claim 1, further comprising:
receiving, by the display device, the calibration pattern from an external component that is not part of the display device.

9. A method for calibrating at least one image sensor of a driver assistance system, the method comprising:
transmitting a calibration pattern to a display device located outside a vehicle for imaging the calibration pattern; and
transmitting a control command to the image sensor to capture the calibration pattern.

10. The method according to claim 9, further comprising:
obtaining the calibration pattern captured by the image sensor;
comparing the calibration pattern captured by the image sensor with the calibration pattern,
determining, as a result of the comparison, at least one image sensor setting to be changed; and
transmitting the at least one image sensor setting to be changed to the image sensor.

11. The method according to claim 9, further comprising:
orienting or positioning the display device in relation to the vehicle.

12. The method according to claim 9, wherein the calibration pattern is transmitted by an external component to the display device, wherein the external component is not part of the display device.

13. The method according to claim 8, wherein the external component comprises at least one of a vehicle diagnostic device, a mobile terminal, or a server, or is formed by same.

14. The method according to claim 9, wherein the image sensor is a camera or comprises a camera.

15. A device for calibrating at least one image sensor of a driver assistance system, comprising:
a display device located outside a vehicle for imaging a calibration pattern; and
a first communication unit to transmit a control command to the image sensor to capture the calibration pattern imaged by the display device.

16. The device according to claim 15, wherein the display device comprises at least one of a screen for displaying the calibration pattern or a projector for projecting the calibration pattern.

17. The device according to claim 15, wherein the first communication unit is configurable to transmit the calibration pattern to the display device.

18. The device according to claim 15, further comprising:
a memory with a first database which comprises two or more calibration patterns.

19. The device according to claim 15, further comprising at least one of: a sensor to determine at least one of a distance, or a position, or an orientation of the display device relative to the vehicle, a positioning component to position the display device in relation to the vehicle, or an orientation component for orienting the display device in relation to a vehicle.

20. The device according to claim 15, wherein the device is not part of the vehicle, and wherein the device is located outside the vehicle.

21. The device according to claim 15, wherein the display device is configurable to receive the calibration pattern from an external component that is not part of the display device.

22. The device according to claim 15, wherein the image sensor is a camera or comprises a camera.

23. The device according to claim 15, further comprising a server, the server including:
a second communication unit;
a second control and processing unit; and
a second database;
wherein the second database comprises two or more calibration patterns, wherein the second communication unit is configurable to transmit the calibration pattern to the display device and to transmit the control command to the image sensor.
